(19) United States
(12) Patent Application Publication
(10) Pub. No.: US 2012/0016807 A1
(43) Pub. Date: Jan. 19, 2012

(54) SYSTEM AND METHOD FOR DYNAMIC PERSONALIZED FINANCIAL ILLUSTRATIONS

(75) Inventors: Richard J. Wirth, West Hartford, CT (US); Erin Christine Schwerzmann, Simsbury, CT (US)

(73) Assignee: Hartford Fire Insurance Company, Hartford, CT (US)

(21) Appl. No.: 12/837,149

(22) Filed: Jul. 15, 2010

(51) Int. Cl. G06Q 40/00

(52) U.S. Cl. 705/36 R

(57) ABSTRACT

A personalized financial illustration system includes a computer or data processing device, which is configured to implement a method for generating personalized financial illustrations based on summary prospectus format or chassis, incorporating a potential investor's selections of variables defining investment goals, constraints, and an investment plan.

### FIELD OF THE INVENTION

The present invention relates to financial sales and education services and, more particularly, to personalized financial illustrations of potential investment outcomes, limitations, and costs.

### BACKGROUND OF THE INVENTION

Potential investors confront a wide array of investment options, including security investments as well as real estate, commodities contracts, independent small business ownership, or franchise operation. Commonly, long-term retirement investors trend toward investments in stocks, bonds, mutual funds, or variable annuities.

Under federal securities laws and regulations, the terms, conditions, costs, and risks of any investment that might be characterized as a security should be fully disclosed to prospective investors through a prospectus. Each prospectus must comply with federal securities law requirements for detail and clarity. Particularly for a complicated security investment, such as, for example, a variable annuity with guarantee minimum withdrawal or death benefits, a prospectus with detailed explanation of all possible options can be undesirably confusing to some potential investors.

“Plain English disclosure” and “layered disclosure” offer two potential improvements on the present prospectus requirements. Generally, a plain English disclosure would eschew legal terminology for the sake of clarity, while a layered disclosure would provide sequential access to a “summary prospectus” layer followed by one or more layers of further clarification and explanation. Industry leaders and the Securities and Exchange Commission (SEC) are interested in finding effective ways to produce a layered plain English disclosure that is any more useful to potential mutual fund and variable annuity investors. In particular, plain English explanations of relevant legal terms necessarily can be verbose. Additionally, it can be challenging to effectively present to a potential investor all potential alternative or optional terms, conditions, costs, and risks of investment, without being equally as confusing as a non-layered prospectus. It is anticipated that these efforts will culminate in the development of a summary variable annuity prospectus that would allow prospective investors to segue from this plain English document to more detailed descriptions of relevant features within a statutory prospectus. Unfortunately, even the summary prospectus approach will not be personalized based on each prospective investor's particular investment selections nor will this disclosure instrument allow prospective investors to manipulate data to assess how any particular variable annuity may or may not be suitable based upon their idiosyncratic needs or circumstances.

Although some efforts previously have been made to develop illustration tools that can offer limited interactive estimates of factors such as premium costs based on life expectancy, policy benefits, and policy term, these previous efforts have not focused on the specific informational requirements and options associated with guaranteed minimum benefit riders found in many variable annuities, and have not achieved optimal clarity of illustration. Accordingly, a need still exists for some method or system that can produce for a potential investor a personalized and easily understandable financial illustration disclosing potential outcomes, limitations, and costs of guaranteed minimum benefits within a variable annuity. For ease of use and consistency, an optimal manifestation of such an illustration tool should be based on a summary variable annuity prospectus template.

### SUMMARY OF THE INVENTION

According to the present invention, a personalized financial illustration system includes a computer or data processing device, which is configured to implement a method for generating a personalized financial illustration based on a summary prospectus format and incorporating a potential investor's selections of variables defining investment goals, constraints, and an investment plan.

According to some embodiments of the present invention, a personalized financial illustration system includes a computer or data processing device, which includes a processor connected in communication with a data storage device, a display device, and an input device. The processor and the memory are configured to transmit to the display device requests for information relevant to a potential investor's investment goals, constraints, and plans, and to receive from the input device a potential investor's responses to at least some of the requests. The processor and the memory are further configured to display a personalized financial illustration incorporating pre-set assumptions modified by the received responses.

According to some embodiments of the present invention, a personalized financial illustration system includes a computer or data processing device, which includes a processor connected in communication with a data storage device, a display device, and an input device. The processor and the memory are configured to transmit to the display device requests for information relevant to a potential investor's investment goals, constraints, and plans, and to receive from the input device a potential investor's responses to at least some of the requests. The processor and the memory are further configured to implement one or more regulatory compliance engines to generate a personalized financial illustration based on a summary prospectus format and incorporating pre-set assumptions modified by the received responses.

According to some embodiments of the present invention, a personalized financial illustration system includes a computer or data processing device, which includes a processor connected in communication with a data storage device, a display device, and an input device. The processor and the memory are configured to transmit to the display device a preliminary financial illustration incorporating pre-set assumptions, to receive from an input device a potential investor's modifications to the assumptions, and to transmit to the display device a personalized financial illustration incorporating the received modifications to the pre-set assumptions.

These and other objects, features and advantages of the present invention will become apparent in light of the detailed description of an exemplary embodiment thereof, as illustrated in the accompanying drawings.

### BRIEF DESCRIPTION OF THE DRAWINGS

FIG. 1 shows in schematic view a computerized system configured to implement a computerized method for personalizing financial illustrations according to an embodiment of the present invention;

FIG. 2 shows an exemplary personalized financial illustration displayed in graphical format by the system shown in FIG. 1;

FIG. 3 shows an exemplary personalized financial illustration displayed in tabular format by the system shown in FIG. 1;

FIG. 4 shows a flow diagram of a method for personalized financial illustration, as implemented by the system shown in FIG. 1;

FIG. 5 shows a pop-over investment pick graphic displayed by the system shown in FIG. 1;

FIG. 6 shows in schematic view a layered prospectus chassis personalized by the system shown in FIG. 1;

FIG. 7 shows in schematic view a standalone server implementation of the system shown in FIG. 1;

FIG. 8 shows in schematic view a distributed network architecture implementation of the system shown in FIG. 1; and

FIG. 9 shows in schematic view a multi-touch handheld device implementation of the system shown in FIG. 1.

### DESCRIPTION OF PREFERRED EMBODIMENTS

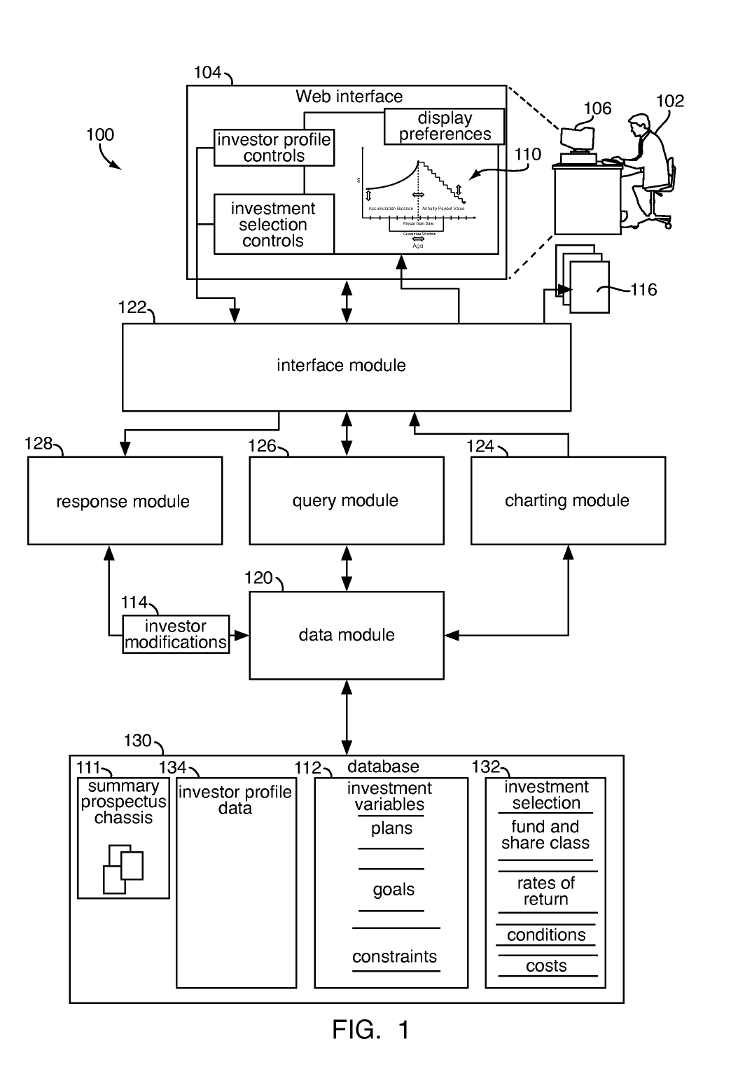

Referring to FIG. 1, the present invention relates to a computerized system 100, which assists potential investors in assessing their investment goals and plans in view of known constraints. In use, an investor 102, or another person acting on behalf of the investor, may access the computerized system 100 via a secure web-implemented interface 104 displayed at an investor or user device 106. The investor device 106 can be connected to a wire network, as for example a laptop or desktop computer, or can be wirelessly networked, as for example a mobile handheld device. Via the secure web-implemented interface 104, the computerized system 100 displays a financial illustration 110 based on a summary prospectus format or “chassis” 111 and incorporating investment variables 112, and receives investor modifications 114 to the variables 112. The system 100 then generates a personalized financial illustration 116 and incorporating the investor's modifications 114, for use by the investor 102 in evaluating the risks and potential benefits of at least one prospective investment plan.

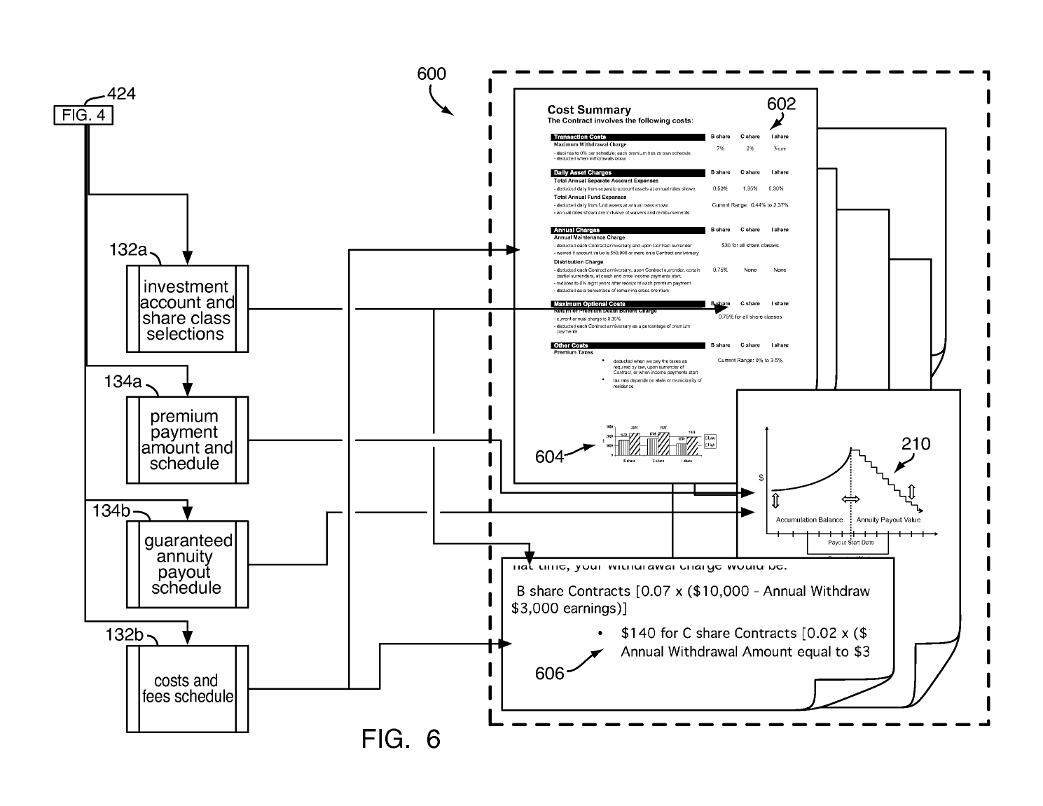

When considering the computerized system 100 and methods disclosed herein, it should be appreciated that the logical operations of various embodiments of the present invention for providing an investor with a personalized financial illustration may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated herein, and making up the embodiments of the present invention described herein are referred to variously as operations, structural devices, acts, actions or modules. It will be recognized by one skilled in the art that these operations, structural devices, acts and modules may be implemented in software, in firmware, in special purpose digital logic, and any combination thereof without deviating from the spirit and scope of the present invention as recited within the referrals attached hereto. In an exemplary embodiment, the system 100 includes a data module 120, an interface module 122 for providing the secure web-implemented interface 104 (“web interface”) and for generating a personalized financial illustration 600 (as further discussed below with reference to FIG. 6), a charting module 124 for updating the financial illustration 110 within the web interface 104, and a query module 126 and a response module 128 for communicating with the investor 102 via the web interface 104.

The data module 120 maintains and accesses a database 130, which stores investment variables including plan and goal pre-set variables 112, investor modifications 114 to the pre-set variables 112, and investment fund and share class selections 132. The database also stores investor profile data 134 such as, by way of example, date of birth, scheduled income, investor responses to queries about plans and goals, and investor modifications to investment plan and goal variables and constraints.

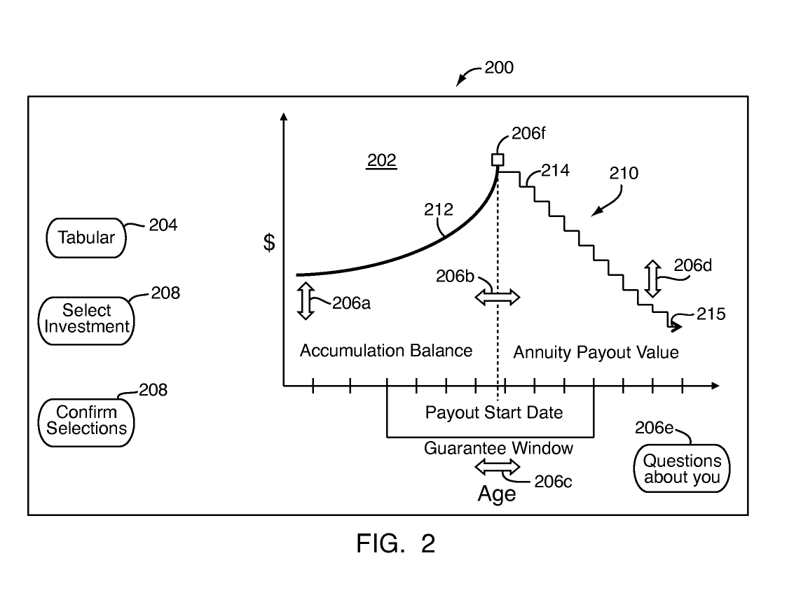

The interface module 122 provides the web interface 104 to the investor device 106. Referring to FIG. 2, an exemplary web interface 200 includes a financial illustration 202, display preference controls 204, investor profile controls 206, and investment selection controls 208. The illustration area 202 may be configured, according to investor selections of the display preference controls 204, to display either a tabular or a graphical personalized financial illustration 110. The display preference controls 204 also can be used to adjust language, font, and alphabet selections, color palettes, and other visual preferences, as well as paper or electronic delivery formats, delivery contact information, and direct marketing opt-ins.

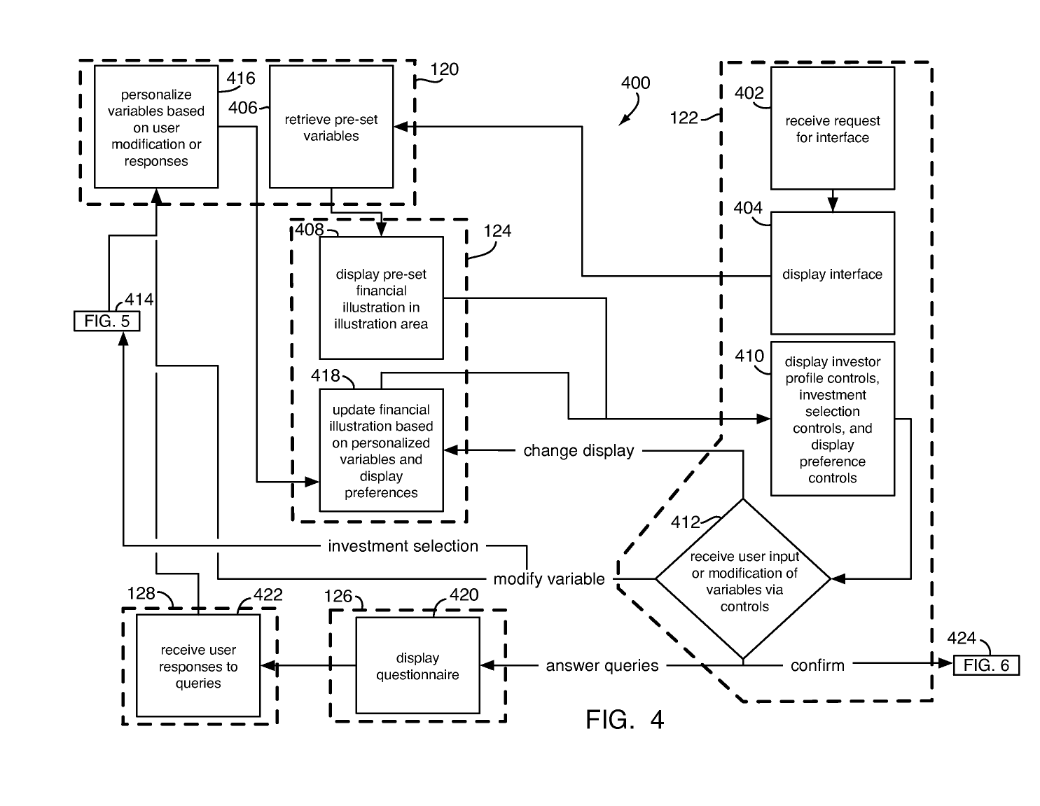

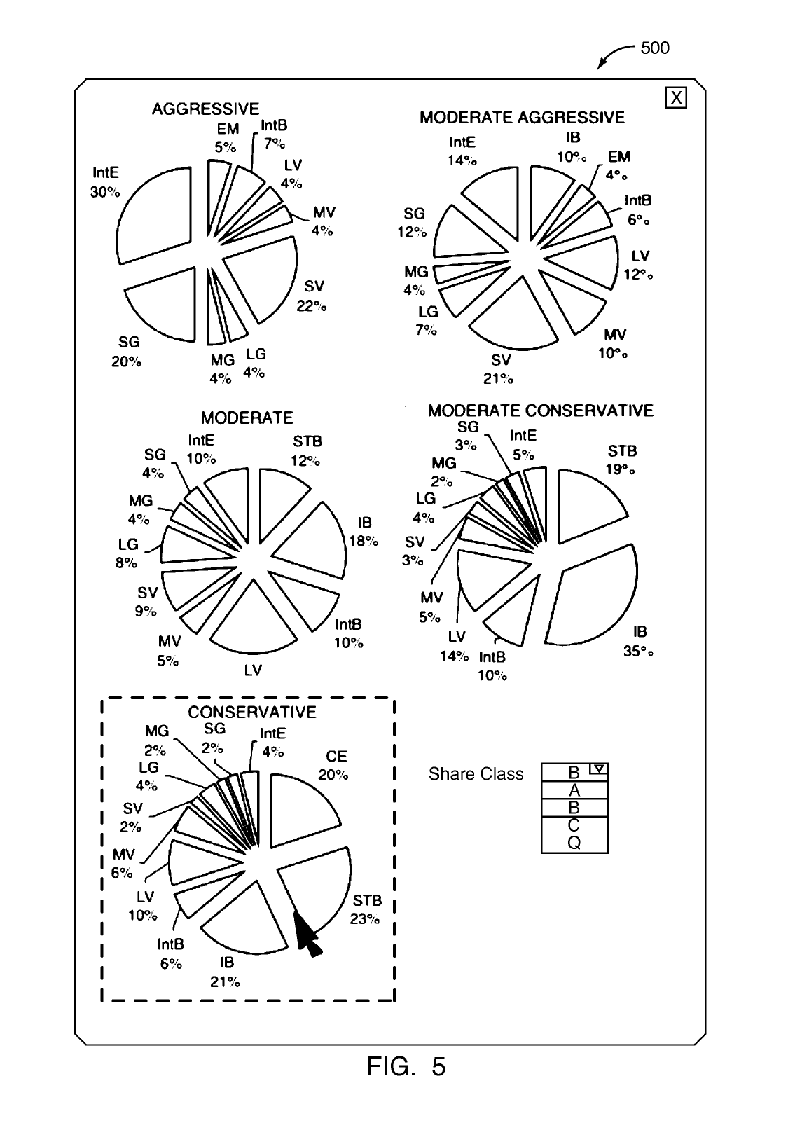

The investor profile controls 206 can be used to modify investment plan and goal variables 112 and to enter investor profile data 134. In some embodiments, the investor profile controls 206 include plan and goal controls 206a-d for inputting investor modifications 114 to the investment variables 112. The investor profile controls 206 can also include a questionnaire button 206e for activating the query module 126 to obtain investor profile data 134. The investment selection controls 208 can be used to identify a particular investment and share class for use by the charting module 124 in generating the personalized financial illustration 110, as further discussed below with reference to FIGS. 4 and 5.

In FIG. 2, the illustration area 202 is shown displaying a personalized financial illustration 110 in graphical format 210. The graphical format illustration 210 includes an accumulated balance curve 212, annuity payout steps 214 depleting the accumulated balance from a payout start date, and handle-style investor profile controls 206 for receiving investor modifications 114 to the investment variables 112 underlying the personalized financial illustration. The handle-style controls can be dynamically adjusted by click-and-drag using a mouse or a touch screen. In particular, handle 206a can be used to adjust a premium payment schedule plan variable; handle 206b can be used to adjust a payout start date plan variable; handle 206c can be used to adjust a payout guarantee window; and handle 206d can be used to adjust a payout schedule plan variable. Note that arrow 215, at the right side, indicates continuing lifetime annuity payouts after depletion of the annuity payout balance. Optionally, the lifetime payout arrow 215 also can be made draggable, such that dragging the arrow 215 to the right will tend to reduce the height and/or frequency of the payout steps 214. Optionally, handle 206f at the peak of the accumulated balance curve can be used as an investment selection control 208, and can be dragged to select a different investment fund or share class. Alternatively, the investment selection controls 208 can include a select button 208a that can be activated to provide a pick graphic 500 displaying a collection of asset allocation models likely relevant to the investor's particular financial plans and goals (as further discussed below with reference to FIG. 5), and a confirm button 208b that activates the interface module to generate a personalized financial illustration 600 (as further discussed below with reference to FIG. 6).

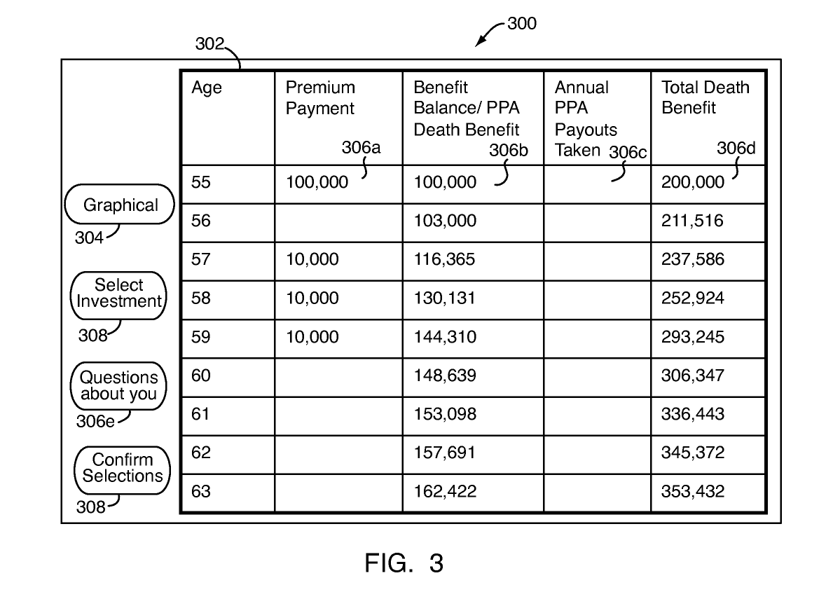

In FIG. 3, the web interface is shown in a tabular display mode 300 wherein the personalized financial illustration is presented as a table 302. The tabular display mode also includes display preference controls 304, investor profile controls 306, and investment selection controls 308. The investor profile controls 306 are implemented as editable text fields 306 within the table 302, for example fields showing premium payments 306a, account balances 306b, scheduled payouts 306c, and benefit values 306d. By clicking and typing in any of the editable fields, an investor 102 may provide modifications 114 to the investment variables 112 stored in the database 130 shown in FIG. 1. Some fields, such as the account balances 306b and the benefit values 306d, may be locked against editing. Alternatively, the premium payments 306a and/or the investment selection may be updated according to investor edits in the account balances 306b. The tabular mode web interface 300 also includes a questionnaire button 306e, which activates the query module 126 much like the questionnaire button 206e shown in FIG. 2.

Referring back to FIG. 1, the charting module 124 periodically accesses the database 130 via the data module 120 to obtain plan and goal variables 112, historic rates of return, and/or investor profile data 134. Based on the historic returns on the selected investment fund and share class 132, the charting module 124 generates and transmits to the web interface 104 the personalized financial illustration 110 of what an investor's current account balance might be if the investor already had paid premiums and taken payouts according to the investment variables 112. For example the illustration 110 may show what an investor's account balance and future payout schedule would be if the investor already had paid in premiums over the past decade, and planned to start receiving guaranteed annuity payouts two years in the future. Exemplary personalized financial illustrations are better shown in FIGS. 2 and 3. Such illustrations may include back-projections, based on historical data, of how an investor's accumulated account balance would have fluctuated, based on the investor's selected investment funds and/or share classes and premium payments, starting from a point in the past, as if the investor's selected payout date and guarantee window were at the present date.

Referring back to FIG. 1, when activated by one of the buttons 206e or 306e in the web interface 104, the query module 126 retrieves a set of investment profile questions from the database 130, and modifies the illustration area 202 of the web interface 200 or 300 to prompt an investor using the interface to provide information, for example by displaying each of the investment profile questions along with controls for responding to the questions—for example, multiple-choice “radio” buttons or check boxes. Exemplary queries may include, by way of example without limitation, questions related to the following topics:

| Topic | Exemplary Questions |
|---|---|
| Share class (expense | Do you plan to hold this variable |
| tables and examples | annuity for more than 8 years? |
| in illustration 600 will be | Do you want to avoid contingent |
| adjusted to reflect class fees). | deferred sales charges by paying a |
| | front end sales load? |
| | What share classes are suitable based |
| | on your investment time horizon? |
| Fund selections (expense tables in | What is your risk appetite and |
| illustration 600 will be adjusted to | tolerance? (can link to a risk tolerance |
| reflect fund fees). | questionnaire). |
| | Do you want to use an asset allocation |
| | model portfolio? (Refer to the choices |
| | of model portfolios offered. Can link to |
| | pick graphic 500). |
| | Are any of the riders chosen subject to |
| | investment restrictions? (Refer to |
| | investment restrictions for more |
| | information. Can link to help display |
| | explaining investment restrictions). |
| | What are the historical costs and |
| | investment performance for each fund? |
| | (can link to linked list of funds with |
| | pop-up historical performance data). |
| Investment Amount (Expense | How much do you intend to invest? |
| tables and examples in | Should (or are) you invest(ing) assets |
| illustration 600 adjust | from a 401(k) or other qualified plans? |
| to reflect investment as | Do you have other resources to cover |
| adjusted for expenses). | your short-term or emergency needs |
| | after making this investment? |
| Optional Benefits | Do you wish to supplement your |
| (deselected benefits are hidden, | standard death benefits? |
| expense tables and examples | How much are you willing to pay for |
| adjust in illustration 600 to | these additional benefits? |
| reflect fees and disclosures). | |
| State of Residency | In what state do you live? |
| (premium tax and state | |
| specific variation disclosures | |
| adjusted accordingly | |
| in illustration 600). | |
| Dollar Cost Averaging | Do you wish to periodically add more |
| Programs: | money to the contract? |
| Investment Allocation | How do you wish to split your |
| (Illustration 110 | investment between funds and the |
| and the illustration 600 | Personal Pension Account? |
| populate as applicable). | Do you have enough money in the |
| | funds and other assets to meet your |
| | short term or emergency needs? |
| Personal Pension Account Election | When do you anticipate needing to |
| (Expense tables and examples in | start receiving payouts? (response can |
| illustration 600 adjust to reflect fees | trigger pop-up with following |
| and disclosures and illustration 110 | information: |
| populates as applicable). | Factors postponing Target Income Age |
| Target Income Age/PPA Start Date | include whether you need to pay for |
| (also can be adjusted by handle 206b | certain expenses like college |
| or by text entry in table 302). | education, medicalbills, care for |
| * Personal Pension | elderly parents, etc. before starting |
| Account (PPA) is a | payouts. |
| trademark of The Hartford. | Factors accelerating Target Income |
| | Age include how long do you expect to |
| | live given your medical condition, |
| | family history or other factors). |
| | Will you be over age 59 ½ at the time |
| | you start receiving payouts? (Tax |
| | disclosure pop up triggered). |
| Subsequent Premium | Do you expect to transfer Contract |
| payments (Enter Data - Each | Value into the Personal Pension |
| new Premium payment | Account? |
| triggers new Accumulation | Do you expect to make subsequent |
| Balance/Maximum | Premium payments into the Personal |
| Guaranteed Payout Rate tables). | Pension Account? |
| | Do you expect to use a transfer |
| | program to make subsequent Premium |
| | payments into the Personal Pension |
| | Account? |

Still referring to FIG. 1, the web interface 104 passes back to the response module 128 each investor modification 114 made via the investor profile and investment selection controls 206 or 306 and 208 or 308. The response module 128 receives from the web interface 104 the investor's responses to the various queries. The response module 128 processes the investor responses, and appropriately updates the database 130 via the data module 120. The interface module 122 also calls the charting module 124 to update the personalized financial illustration 110 according to each investor modification, so that the illustration area 202 or 302 consistently reflects the investor's stated goals, plans, constraints, and display preferences.

Referring to FIG. 4, the computerized system 100 carries out a computer-implemented method 400 for producing personalized financial illustrations. Referring also to the modules shown in FIG. 1, the method 400 includes a step 402 of receiving, in the interface module 122, an investor's request for the web interface 104. At a step 404 the interface module 122 then displays the web interface 104. At a step 406 the interface module 122 calls the data module 120 to retrieve pre-set investment variables 112, and at a step 408 the charting module 124 displays a graphical financial illustration 210 in the illustration area 202 of the web interface 104, based on the pre-set investment variables 112. At a step 410 the interface module 122 displays display preference controls 204, investor profile controls 206, and investment selection controls 208. At a step 412 the interface module 122 receives an investor input actuating one of the controls 204, 206, or 208, and then performs one of the following steps in response to the investor input:

At a step 414 in response to an investor actuation of “Select” investment selection control 208a, the interface module 122 displays a pick graphic 500 for selecting an investment allocation model, as further discussed with reference to FIG. 5.

At a step 416 in response to investor selection from the pick graphic 500, or in response to investor actuation of one of the investor profile controls 206, the interface module 122 calls the data module 120 to personalize investment variables 112 and/or investor profile data 134 based on the investor input (modification or response).

At a step 418 the interface module 122 calls the charting module 124 to update the financial illustration 110 to graphical format 210 or to tabular format 310, incorporating any personalization or modification of the variables 112 or the investor profile data 134.

At a step 420, the interface module 122 calls the query module 126 to display an investor profile questionnaire as discussed above, and then at a step 422 the query module 126 calls the response module 128 to parse the investor responses. The interface module then performs steps 416 and 418 as discussed above.

At a step 424, the interface module 122 generates a personalized financial illustration 600, as further discussed below with reference to FIG. 6, in response to an investor actuation of the “Confirm” investment selection control 208b.

Referring to FIG. 5, investment selection pick graphic 500 includes a plurality of generalized investment allocation model illustrations, for example pie charts as shown in FIG. 5. The allocation model illustrations relate to specific modes of investment or to specific named security investment opportunities, and generally show how funds invested in such modes or opportunities will be allocated. For example, the “CONSERVATIVE” investment allocation model illustration selected in FIG. 5 shows 4% International Equity investments, 20% Cash Equivalent investments, and 23% Short Term Bond investments. The investment selection pick graphic 500 may also include a pull-down menu 502 for selecting a share class, in case the various investment allocation model illustrations correspond to specific named investment opportunities offering various classes of shares. Share classes may affect, among other things, cost ratios, cost loading schemes (front-, even-, or back-loaded), and optional benefits including, by way of example, availability of a death benefit, of guaranteed minimum payouts, or of guaranteed lifetime payouts. On selection of an allocation model illustration and a share class, for example by clicking a mouse, the pick graphic 500 closes and returns the investor's selections to the interface module 122 and to the data module 120 for further use, according to data transfer methods familiar to those of skill.

Referring to FIG. 6, in conducting step 424 of the computer-implemented personalization method 400 discussed above, the computerized system 100 generates a personalized financial illustration 600 by modifying a plain-English summary prospectus chassis (including a graphical financial illustration 210, a cost summary 602, a high-low cost estimate 604, and an exemplary costs and fees calculation 606) to incorporate the investor's selected investment account and share class 132a, the associated cost and fee schedule 132b, the investor's planned premium payment amount and schedule 134a, and the investor's guaranteed annuity payout schedule 134b. For example, the charting module 124 can perform step 424.

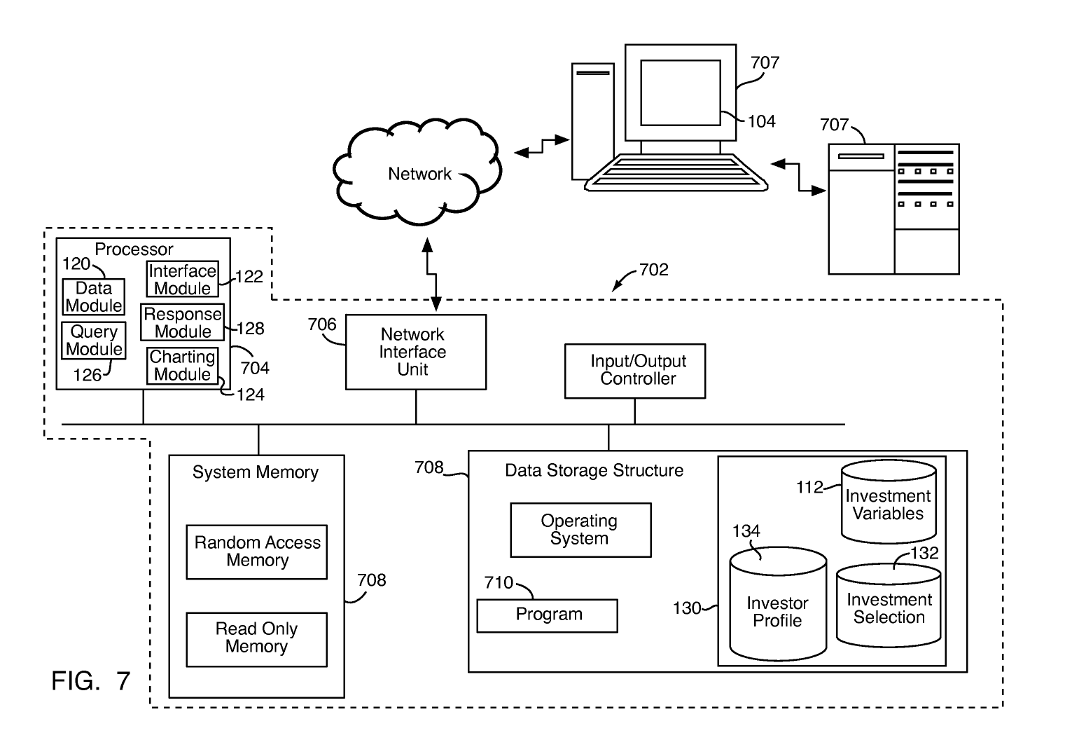

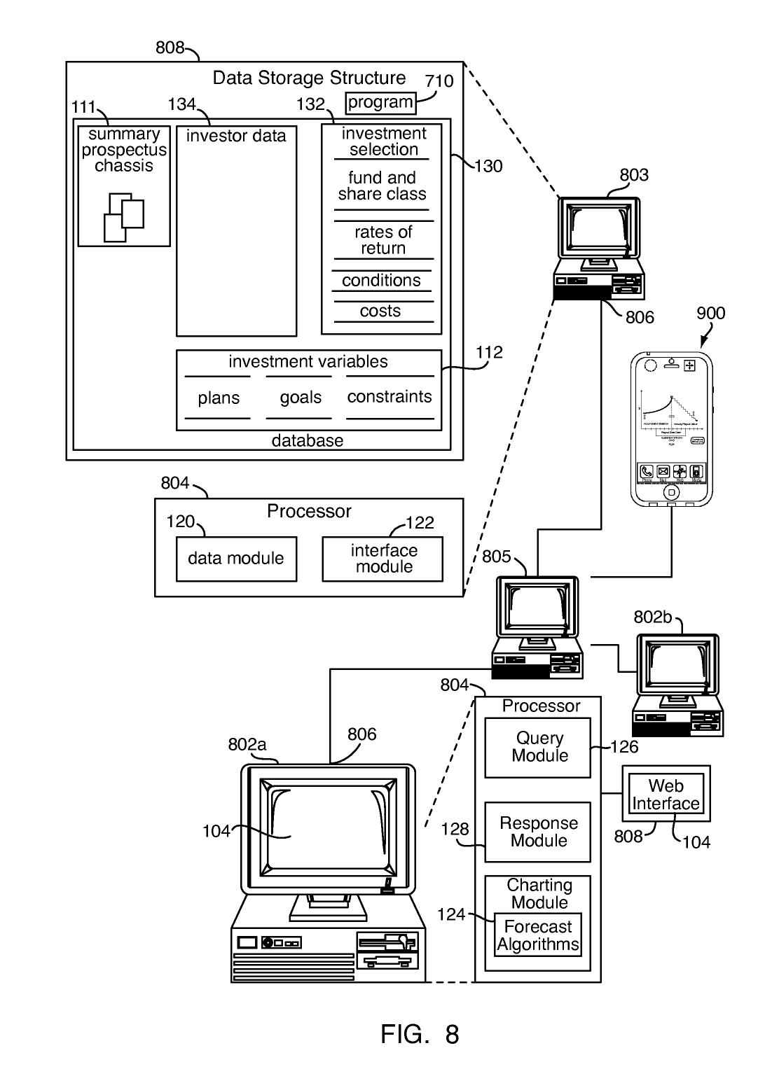

Typically, a cost and fee schedule 132b will vary depending on an investor's premium payments schedule 134a, the investor's selected fund and share class 132a, the investor's planned withdrawals 134b (plus any margin to account for unexpected withdrawals and associated penalties), and any annuity premium taxes applicable to the investor's state of domicile. Referring to FIGS. 7 and 8, the computerized system 100 may be implemented in many different ways. For example, the computerized system 100 may be implemented in a central server architecture 700 that is centered on a conventional network host computer 702, as shown in FIG. 7. Alternatively, and preferably, the computerized system 100 can be implemented in distributed network architecture 800, as shown in FIG. 8.

Referring to FIG. 7, the network host computer 702 includes at least one controller, processor, or central processing unit (CPU) 704, at least one communication port or network interface unit 706, and one or more data storage structures 708. The processor 704 may include one or more conventional microprocessors and one or more supplementary co-processors such as math co-processors. The communication port 706 may include multiple communication channels for simultaneous communication with, for example, other processors, display units, servers, or client terminals 707. Devices in communication with each other need not be continually transmitting to each other. On the contrary, such devices need only transmit to each other as necessary, may actually refrain from exchanging data most of the time, and may require several steps to be performed to establish a communication link between the devices.

For example, the communication port 706 may include wire modems, wireless radio, infrared, visible laser, or UV laser transceivers, or audio transceivers. The communication port 706 and the one or more data storage structures 708 are in communication with the processor 704 to facilitate the operation of the network host computer 702. The data storage structures may comprise an appropriate combination of magnetic, optical and/or semiconductor or flash memory, and may include, for example, RAM, ROM, an optical disc such as a compact disc and/or a hard disk or drive. The processor and the data storage structures each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wireline medium.

At least one of the data storage structures 708 is encoded with (i) a program and/or algorithm(s) (e.g., computer program code and/or a computer program product) 710 adapted to configure one or more of the processors 704 to emulate the various modules of the computerized system 100, as described in detail hereinabove; and/or (ii) at least one database configured to store information required, manipulated, or produced by the computerized system 100 in execution of the program, such as, for example, database 112.

The computer program 710 for configuring the processor 704 to implement the computerized system 100 (and other functions described herein) can be developed by a person of ordinary skill in the art, and is not described in detail herein. Suitable computer program code may also be provided for performing numerous other functions such as generating notifications at selected time intervals. For example, in addition to instructions for configuring the processor to implement the computerized system 100, the program 710 also may include program elements such as an operating system, a database management system and “device drivers” that allow the processor to interface with computer peripheral devices (e.g., a video display, a keyboard, a computer mouse). The processor 704 may read the instructions of the program 710 from the data storage structures 708. The program 710 may be stored, for example, in a compressed, an uncompiled and/or an encrypted format, and may include computer program code. While execution of sequences of instructions in the program 710 will configure the processor 704 to emulate one or more of the modules of the computerized system 100, hard-wired circuitry may be used in place of, or in combination with, software instructions for implementation of the computerized system 100. Thus, embodiments of the present invention are not limited to any specific combination of hardware and software.

Each user device or computer or display unit or server or client terminal 707 may include any one or a combination of a keyboard, a computer display, a touch screen, LCD, voice recognition software, an optical or magnetic read head, or other input/output devices required to implement the above functionality. Each display unit may include any one or a combination of a computer display, a printer, a CD/DVD burner, a magnetic tape drive, a magnetic disk drive, an LCD array, a voice speaker, a network connection, or similar output device. At least one of the user devices or computers or client terminals, or of the display units, may be configured according to the computer program, or according to other instructions, to provide various user interfaces for receiving data and for displaying messages including display of the WEB INTERFACE 104.

Referring to FIG. 8, wherein, similar numbers indicate components similar to those shown in FIG. 7, the distributed network architecture includes several module servers 802a-n and at least one data server 803 connected by a communications hub 805. Each of the module servers 802a-n and the data server 803 includes at least one associated processor 804, at least one communication port 806, and one or more data storage structures 808. The data server 803 is configured to maintain the database 112 in response to instructions and queries received from the various module servers 802a-n, according to the program 710. The communications hub 805 serves as a primary communication link between the module servers 802, the data server 803, and other servers, client or user terminals and related devices including one or more display units. The communications hub 805 may have minimal processing capability itself, serving primarily as a communications router, or may also act as another module server. A variety of communications protocols may be part of the system, including but not limited to: Ethernet, SAP, SAS™, ATP, Bluetooth, and TCP/IP.

In the distributed network architecture, as shown in FIG. 8, each of the module servers 802 is configured by execution of the program 710 to emulate one or more of the various modules and processes of the computerized system 100. For example, the data server 803 may be configured by the program to emulate the data module 120 and the interface module 122, while module server 802a may be configured by the program to emulate the charting module 124, the query module 126, and the response module 128.

In the central server architecture shown in FIG. 7 or in the distributed network architecture shown in FIG. 8, the program 710 may be embodied in a computer-readable medium, other than any of the data storage structures, that provides or participates in providing instructions to the processor (or any other processor of a computing device described herein) for execution. The computer-readable medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Transmission media include coaxial cables, copper wire and fiber optics, including the wires that comprise a system bus coupled to the processor. Transmission media may carry acoustic or light waves, such as those generated during radio frequency (RF) and infrared (IR) data communications.

Common forms of the computer-readable medium can include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read. Various forms of the computer-readable medium may be involved in configuring the processor (or any other processor of a device described herein) to implement the modules and processes of the computerized system 100.

For example, as shown in FIG. 8, the program 710 may initially be borne on a magnetic disk of a remote computer. The remote computer can load the instructions into its dynamic memory and send the instructions over a telephone line using a first modem. A second modem local to the communications hub can receive the data on the telephone line and can use an infrared transmitter to convert the data to a wireless signal. An infrared detector of the communications hub can receive the data carried in the wireless signal and can transfer the data through the communications hub to one of the module servers or to the data server. In addition, instructions may be received as electrical, electromagnetic, or optical signals, conveyed either on optical or electromagnetic cables or as wireless carrier waves that carry data streams representing various types of information.

One advantage of the present invention relates to effectively implementing a summary variable annuity prospectus. This document will provide key financial details that an investor needs to know such as contract expenses, fund expenses and surrender charges. The inventive system and method for personalized financial illustration permit a summary variable annuity prospectus chassis to be customized based on specific detail provided by a potential investor or their broker. For instance, if the investor chose a specific fund, the inventive system would modify the prospectus chassis to disclose investment cost ratios for that fund selection, and total investment costs based on planned premium payments and projected performance. Unlike a generic illustration presently provided in investment prospectus, data directly relevant to the potential investor would appear in the customized or personalized financial illustration based on the prospectus chassis.

For example, if the potential investor wanted to know how their PPA Benefit Balance might grow depending on how long they deferred starting income. The application would show how the tail of the graph in the embedded image moves up or down. Let's assume that the potential investor wanted to compare different share classes. The bar graphs would move up or down based on the specifics supplied.

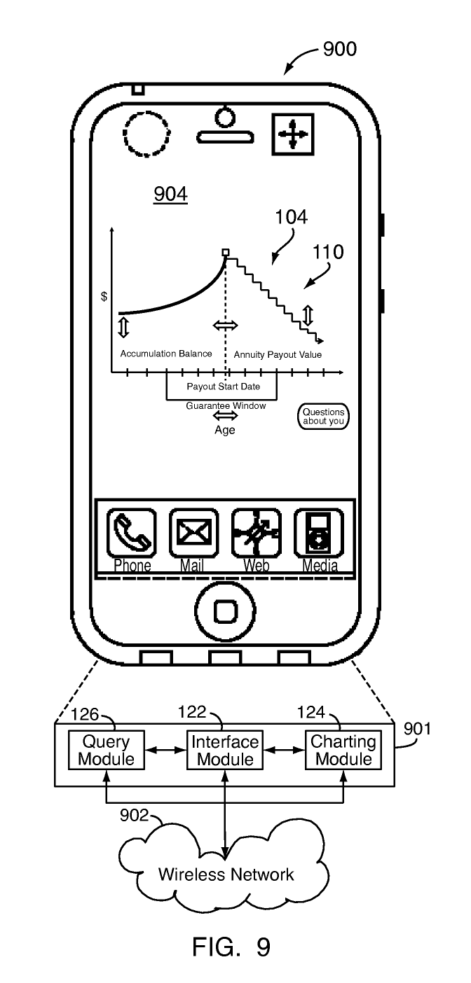

By having the embedded graphics and tables move based on the personalized data provided, the inventive system and method provide disclosure that is superior, in clarity and in relevant detail, to current illustration tables. Referring to FIG. 9, the inventive system and method are particularly effective when implemented via broker websites or via personal devices such as by a smartphone “app”. Touch capable devices, such as by way of example a handheld mobile device 900, permit fingertip dynamic adjustment of controls 206, so that potential investors gain tactile involvement in generating their own personalized financial illustration 600. Larger-screen multi-touch devices, similar to the handheld device 900, also can permit side-by-side comparison and dynamic adjustment of several personalized financial illustrations 600. According to the embodiment shown in FIG. 9, the exemplary handheld touch-capable device 900 is configured with an app 901 that implements the interface module 122, the charting module 124, and the query module 126, and that also connects these modules via a wireless network 902 to the data module 120 and the response module 128. When a user activates the app 901, the interface module 122 displays the web interface 104 on a touch screen 904 of the device 900, while the charting module 124 displays the pre-set graphical financial illustration 110 within the web interface 104. Using the handle controls 206a-e, the user then dynamically adjusts the graphical financial illustration 110 to provide investor modifications 114, via the app 901 and the network 902, to the response module 128. The data module 120, the query module 126, and the response module 128 function as previously discussed with reference to FIGS. 1 and 4, however the app 901 mediates communication between the various modules via the network 902. Thus the embodiment shown and discussed with reference to FIG. 9 provides an easily accessible and lightweight device useful for educating and informing a potential investor regarding the potential benefits and costs of various guaranteed minimum benefits in a variable annuity.

Although this invention has been shown and described with respect to the detailed embodiments thereof, it will be understood by those skilled in the art that various changes in form and detail thereof may be made without departing from the spirit and the scope of the invention.

What is claimed is:

1. A computerized financial illustration system for dynamically personalizing information based on a summary prospectus, comprising:
a database configured to store data including information based on fixed and variable data elements from a summary prospectus;
a data module configured to access said database;
an interface module configured to display an interface to an investor, the interface including controls for receiving investor inputs;
a charting module configured to provide a personalized financial illustration based on information from the summary prospectus, the variable data elements in the personalized financial illustration being dynamically adjustable by actuation of the controls; and
a query-and-response module configured to prompt for inputs from an investor and for receiving the investor inputs,
wherein said modules are connected in mutual communication and are configured to update the variable data elements for the personalized financial illustration according to the investor inputs received via at least one of said interface module and said response module.

2. The system according to claim 1, wherein the interface is a secured web-implemented interface.

3. The system according to claim 1, wherein the summary prospectus is based on a statutory prospectus.

4. The system according to claim 1, wherein prompting inputs includes displaying a pick graphic that includes at least one of: a plurality of clickable asset allocation models for selecting an investment fund, and a pull-down for selecting a share class.

5. The system according to claim 1, wherein providing the personalized financial illustration includes calculating exemplary returns based on historical data corresponding to an investment fund and share class.

6. The system according to claim 3, wherein providing the personalized financial illustration includes deducting from the exemplary returns exemplary costs based at least on an investment fund and share class.

7. The system according to claim 1, said charting module further for generating a personalized financial illustration that includes at least two of: an investor's investment share class selection; an investor's premium payment schedule; an investor's payout guarantee window; and an investor's annuity payout schedule.

8. The system according to claim 1, said charting module further for generating a personalized financial illustration that includes a cost summary according to at least two of: an investor's investment and share class selection; an investor's premium payment schedule; an investor's annuity payout schedule; and a margin for unexpected account withdrawals.

9. The system according to claim 1, wherein receiving investor inputs includes adjusting a premium payment schedule based on an investor's responses to a questionnaire.

10. The system according to claim 1, wherein said query-and-response module includes a query module and a response module, and wherein at least two of said interface module, said charting module, and said query module are implemented in a mobile device, which is in communication with the others of said modules via a wireless network.

11. A computer configured for dynamic personalization of financial illustrations, the illustrations being based on information from at least one summary prospectus, comprising:
a data storage structure implementing a database;
at least one processor connected in communication with said data storage structure, and implementing:
an interface module for displaying, via a user terminal, an interface including controls and an illustration area, further for receiving at least a first investor input actuating one of the controls included in the interface;
a charting module for displaying a dynamically adjustable financial illustration based on the information from the summary prospectus in the illustration area of the interface, based on pre-set investment variables from the summary prospectus;
a data module for accessing and maintaining the database; and
a query module and a response module for prompting and for receiving further investor inputs,
said modules further for performing, in response to the first investor input received via the interface module, at least one of the following steps:
displaying, via the interface, a pick graphic for receiving further investor input;
personalizing, via the data module, investment variables based on the summary prospectus stored in the database, based on the first or further investor input;
personalizing, via the data module, investor profile data stored in the database, based on the first or further investor input;
updating, via the charting module, the financial illustration, according to personalized investment variables;
updating, via the charting module, the financial illustration, according to personalized investor profile data;
displaying, via the interface, an investor profile questionnaire; and
generating, via the charting module, a personalized financial illustration.

12. The computer according to claim 11, wherein the pick graphic includes a pull-down for selecting a share class.

13. The computer according to claim 11, wherein displaying the financial illustration includes calculating exemplary returns based on historical data corresponding to an investment fund and share class.

14. The computer according to claim 13, wherein displaying the financial illustration includes deducting from the exemplary returns exemplary costs based at least on an investment fund and share class.

15. The computer according to claim 11, wherein generating the personalized financial illustration includes generating a personalized graphical financial illustration according to at least two of: an investor's investment share class selection; an investor's premium payment schedule; an investor's payout guarantee window; and an investor's annuity payout schedule.

16. The computer according to claim 8, wherein generating the personalized investment prospectus disclosure includes generating a cost summary according to at least two of: an investor's investment and share class selection; an investor's premium payment schedule; an investor's annuity payout schedule; and a margin for unexpected account withdrawals.

17. The computer according to claim 11, wherein said at least one processor includes a first processor housed in a mobile device and implementing one or more of said modules, and also includes a second processor implementing others of said modules and communicating with said first processor.

18. The computer according to claim 11, wherein the summary prospectus is based on a statutory prospectus.

19. A computer-implemented method for personalizing financial illustrations based on at least one summary prospectus, comprising:
displaying, via a user terminal, an interface including controls and an illustration area, and displaying a financial illustration in the illustration area of the interface, based on pre-set investment variables from the summary prospectus;
receiving a first investor input actuating one of the controls included in the interface; and, in response to the first investor input, at least one of the following:
displaying, via the interface, a pick graphic for receiving further investor input;
personalizing, via a data module, investment variables from the summary prospectus stored in the database, based on the investor input;
personalizing, via a data module, investor profile data stored in the database, based on the investor input;
updating the financial illustration displayed via the interface, according to personalized investment variables based on information from the summary prospectus;
updating the financial illustration displayed via the interface, according to personalized investor profile data;
displaying, via the interface, an investor profile questionnaire; and
generating a personalized financial illustration.

20. The computer-implemented method according to claim 19, wherein the pick graphic includes at least one of: a plurality of clickable asset allocation models for selecting an investment fund, and a pull-down for selecting a share class.

21. The computer-implemented method according to claim 19, wherein displaying the financial illustration includes calculating exemplary returns based on historical data corresponding to an investment fund and share class.

22. The computer-implemented method according to claim 21, wherein displaying the financial illustration includes deducting from the exemplary returns exemplary costs based at least on an investment fund and share class.

23. The computer-implemented method according to claim 19, wherein generating the personalized financial illustration includes generating a personalized graphical financial illustration according to at least two of: an investor's investment share class selection; an investor's premium payment schedule; an investor's payout guarantee window; and an investor's annuity payout schedule.

24. The computer-implemented method according to claim 19, wherein generating the personalized financial illustration includes generating a cost summary according to at least two of: an investor's investment and share class selection; an investor's premium payment schedule; an investor's annuity payout schedule; and a margin for unexpected account withdrawals.

25. The computer-implemented method according to claim 19, wherein personalizing investment variables includes adjusting a premium payment schedule based on an investor's responses to a questionnaire.

26. The computer-implemented method according to claim 19, wherein the summary prospectus is linked to a statutory prospectus.
